(19) United States
(12) Patent Application Publication
(10) Pub. No.: US 2002/0053088 A1
(43) Pub. Date: May 2, 2002

(54) Video server, control apparatus, control method, and recording medium

(76) Inventor: Yosuke Seki, Kanagawa (JP)

Correspondence Address: WILLIAM S. FROMMER, Esq., c/o FROMMER LAWRENCE & HAUG LLP, 745 Fifth Avenue, New York, NY, 10151, US

(21) Appl. No.: 10/016,613

(22) Filed: Oct. 22, 2001

(30) Foreign Application Priority Data
Oct. 23, 2000 (JP) P2000-322635

(51) Int. Cl. H04N 7/173

(52) U.S. Cl. 725/115; 725/116

(57) ABSTRACT

It is an object of the invention to reduce a load of an inquiry of a VCR about time information by a video server. For example, in response to an instruction from a host controller 105, a VCR 101 is controlled by a video server 100, a tape is reproduced by the VCR, and a video signal is outputted. The video signal is supplied to the server, encoded, and recorded. A common reference signal is supplied to the server and VCR. The server executes an encoding process while inquiring of the VCR about the time information. Upon inquiry of the VCR for the time information, the server detects a current state of the VCR and adjusts an inquiry interval of the time information in accordance with a detection result. The server presumes the time information in the VCR on the basis of a reference signal, thereby reducing the number of times of inquiry of the VCR for the time information by the server. Thus, a communication load between the server and the VCR is reduced.

### BACKGROUND OF THE INVENTION

1. Field of the Invention

The invention relates to a video server, a control apparatus, and a control method for reducing a burden of an inquiring process for inquiring time data in the case where a VCR (video cassette recorder) or the like is controlled by a video server or the like and to a recording medium on which a program for realizing such a control method has been recorded.

2. Description of the Related Arts

For example, in a broadcast station, there is used an apparatus called a video server such that a number of audio and video sources (hereinafter, also referred to as AV sources) can be stored and a desired one of the stored AV sources can be reproduced and outputted or AV sources supplied from the outside can be newly and additionally stored under control from the outside. In a video server, for example, a hard disk array is used as a recording medium and a smaller and more light-weighted video server has also been put into practical use.

Such a video server has an encoding function based on, for example, the MPEG2 (Moving Pictures Experts Group 2) system and the supplied AV sources are compression encoded by the MPEG2 system and recorded onto the recording medium. In recent years, a video server having a decoding function of the MPEG2 system in addition to the encoding function has also been proposed. In such a case, a process for compression encoding supplied AV data and storing it and a process for decoding the compression encoded and stored AV data and outputting it to the outside can be executed only by one video server.

For example, a VCR (Video Cassette Recorder) is connected to the video server and audio and video signals (hereinafter, referred to as AV signals) which were reproduced and outputted by the VCR are supplied to the video server and stored as video sources. At this time, the AV signals supplied to the video server are encoded by the encoding function of the video server. In such a construction, a common reference signal is supplied to the video server and the VCR and their operating timings are synchronized. The reference signal comprises, for example, frame pulses corresponding to an interval of frames of the video signal.

In the video server, at the start of the encoding process of the AV data and during the encoding operation, it is necessary to know time information in the VCR, for example, time codes. For this purpose, the video server inquires of the VCR about a tape time of a tape which is reproduced every video frame. This inquiry is made at timing synchronized with the reference signal. That is, in case of the NTSC system, this inquiry is made by the video server of the VCR 30 times a second.

This inquiry is made by serial communication. Therefore, a software load of the communication falls on the video server. Particularly, in the video server having both of the encoding function and the decoding function as mentioned above, an overhead of software increases more than that in, for example, a video server having only the encoding function. Therefore, a communication load of the communication which is made between the video server and the VCR increases, and it is necessary to additionally install a CPU (Central Processing Unit) exclusively for communication into the video server or to use a CPU of higher functions and performance, so that there is a problem of an increase in costs.

Hitherto, the number of communicating times is as large as 30 times a second as mentioned above and there is a problem such that an electric power consumption by a communication driver is large.

Further, there is also a case where the video server is controlled from an external host controller such as a computer apparatus or the like. In this case, in order to obtain the time information in the VCR from the host controller, communication is made once from the host controller to the video server, and communication is further made from the video server to the VCR. Therefore, there is a problem such that a time delay increases and an executable (permission) time of the process for referring to the time information such as a time code or the like in the VCR by the host controller becomes short.

### OBJECTS AND SUMMARY OF THE INVENTION

It is an object of the invention to provide a video server, a control apparatus, and a control method in which a burden of inquiry for time information from the video server to a VCR is small and to provide a recording medium on which a program for realizing such a control method has been recorded.

According to the first aspect of the invention, the above object is accomplished by a video server which can accumulatively record a video signal reproduced by a video signal reproducing apparatus, comprising: communicating means for communicating with the video signal reproducing apparatus which reproduces and outputs the video signal on the basis of time information corresponding to an edition unit of the video signal; control means for allowing the communicating means to communicate with the video signal reproducing apparatus, obtaining the time information on the video signal reproducing apparatus, and controlling the video signal reproducing apparatus so as to reproduce the video signal on the basis of the time information; video signal processing means for performing a predetermined process on the basis of the time information to the video signal outputted from the video signal reproducing apparatus on the basis of the control by the control means; and recording means for recording the video signal subjected to the predetermined process by the video signal processing means, wherein the control means obtains the time information on the video signal reproducing apparatus at a period longer than the edition unit.

According to the second aspect of the invention, there is provided a control apparatus for controlling a reproduction of a video signal by a video signal reproducing apparatus on the basis of time information, comprising: communicating means for communicating with the video signal reproducing apparatus which reproduces and outputs the video signal on the basis of the time information corresponding to an edition unit of the video signal; and control means for allowing the communicating means to communicate with the video signal reproducing apparatus, obtaining the time information on the video signal reproducing apparatus, and controlling the video signal reproducing apparatus so as to reproduce the video signal on the basis of the time information, wherein the control means obtains the time information on the video signal reproducing apparatus at a period longer than the edition unit.

According to the third aspect of the invention, there is provided a control method of controlling a reproduction of a video signal by a video signal reproducing apparatus on the basis of time information, comprising: a communicating step of communicating with the video signal reproducing apparatus which reproduces and outputs the video signal on the basis of the time information corresponding to an edition unit of the video signal; and a control step of allowing the communicating step to communicate with the video signal reproducing apparatus, obtaining the time information on the video signal reproducing apparatus, and controlling the video signal reproducing apparatus so as to reproduce the video signal on the basis of the time information, wherein in the control step, the time information on the video signal reproducing apparatus is obtained at a period longer than the edition unit.

According to the invention as mentioned above, by communicating with the video signal reproducing apparatus which reproduces and outputs the video signal on the basis of the time information corresponding to the edition unit of the video signal and by controlling so as to obtain the time information on the video signal reproducing apparatus at the period longer than the edition unit and reproduce the video signal on the basis of the time information, the predetermined process is executed on the basis of the time information to the video signal outputted from the video signal reproducing apparatus on the basis of the above control and the video signal is recorded. Thus, a communication load to obtain the time information on the video signal reproducing apparatus can be reduced.

The above and other objects and features of the present invention will become apparent from the following detailed description and the appended claims with reference to the accompanying drawings.

### BRIEF DESCRIPTION OF THE DRAWINGS

FIG. 1 is a schematic diagram showing a construction of an example of a system using a video server which can be applied to the invention;

FIG. 2 is a block diagram showing the construction of the example of the video server more in detail;

FIG. 3 is a schematic-diagram for explaining processes in a CPU of the video server;

FIGS. 4A to 4C are schematic diagrams for explaining an odd-number field interrupting process and an even-number field interrupting process;

FIGS. 5A and 5B are schematic diagrams for explaining a method of encoding from a designating point a video signal which is reproduced and outputted from a video tape;

FIG. 6 is a flowchart schematically showing an example of the processes in the video server according to the first embodiment;

FIGS. 7A and 7B are schematic diagrams showing an example of an inquiry of a VCR about time information by the video server in each current state of the VCR;

FIG. 8 is a flowchart showing an example of a normal process;

FIG. 9 is a flowchart showing an example of the odd-number field interrupting process;

FIG. 10 is a flowchart showing an example of a remote transmission interrupting process;

FIG. 11 is a flowchart showing an example of a remote reception interrupting process;

FIG. 12 is a flowchart showing an example of a timer interrupting process;

FIG. 13 is a flowchart showing an example of the even-number field interrupting process;

FIG. 14 is a diagram schematically showing an arithmetic operation and a correction of time information according to the second embodiment;

FIG. 15 is a flowchart showing processes of an example of the arithmetic operation and the correction of the time information according to the second embodiment;

FIG. 16 is a diagram schematically showing processes in which an inquiry about status information and an inquiry about the time information are interlocked;

FIG. 17 is a flowchart showing processes of an example of processes in which the inquiry about the status information and the inquiry about the time information are interlocked;

FIG. 18 is a schematic diagram for explaining a situation such that a delay is caused between a host controller and the video server and a delay is also caused between the video server and the VCR, respectively; and

FIG. 19 is a diagram schematically showing processes in a frame period according to the third embodiment.

### DETAILED DESCRIPTION OF THE PREFERRED EMBODIMENTS

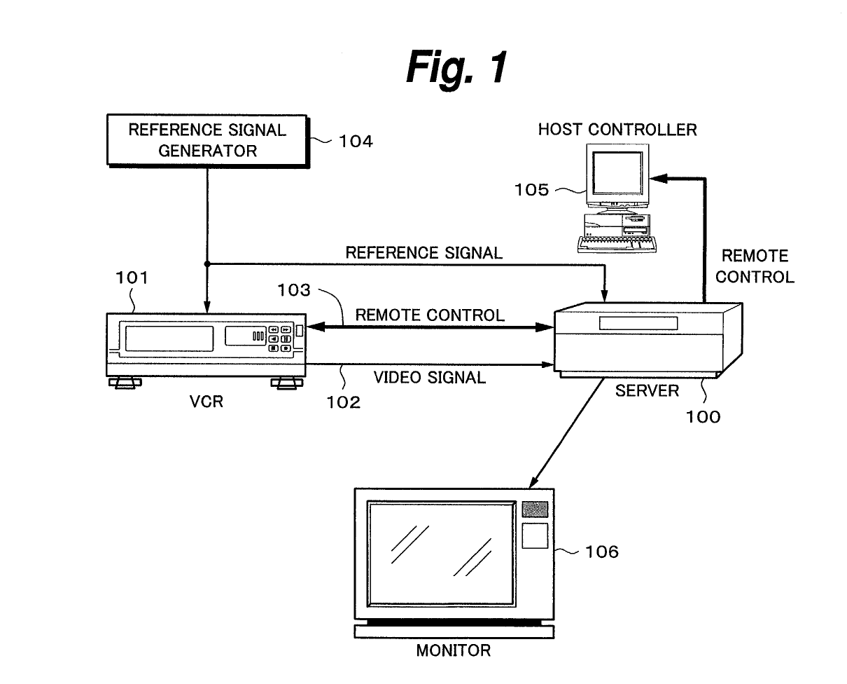

An embodiment of the invention will now be described herein below with reference to the drawings. For ease of understanding, a system which can be applied to the invention will be first described. FIG. 1 shows a construction of an example of a system using a video server which can be applied to the invention. A video server 100 and a VCR 101 are connected by a video cable 102. A video signal which was reproduced and outputted by the VCR 101 is supplied to the video server through the video cable 102.

The video server 100 and VCR 101 are connected by a control cable 103, thereby enabling serial communication to be made via, for example, RS-422. Commands, data, and statuses are transmitted and received between the video server 100 and VCR 101 through the control cable 103, and for example, a reproduction of the video signal by the VCR 101 is controlled. An inquiry of the VCR 101 about time information is also made by the video server 100 through the control cable 103.

A reference signal is generated by a reference signal generator 104 at an interval corresponding to, for example, a video frame. The reference signal is supplied to each of the video server 100 and VCR 101. For example, the reference signal is frame pulses showing a period of a frame as an edition unit of the video signal. The video server 100 and VCR 101 can share timing by the reference signal.

A host controller 105 comprising, for example, a computer is connected to the video server 100, thereby enabling the video server 100 and VCR 101 to be controlled from the host controller 105. For example, a reproduction of video sources stored in the video server 100 can be instructed from the host controller 105. Video data reproduced and outputted from the video sources is supplied to, for example, a monitor 106 and displayed. Are production of a video tape loaded in the VCR 101 or a storage of the video signal reproduced by the VCR 101 into the video server 100 can be also instructed from the host controller 105.

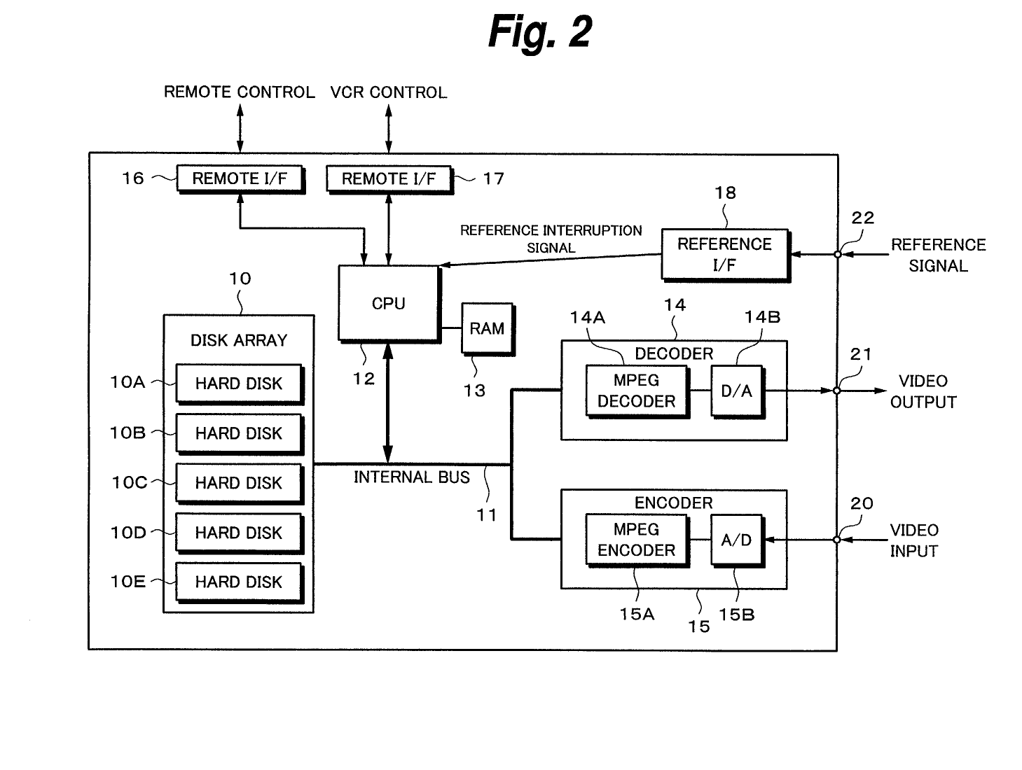

FIG. 2 shows a construction of an example of the video server 100 more in detail. A disk array 10, a CPU (Central Processing Unit) 12, a decoder 14, and an encoder 15 are connected by an internal bus 11. For example, the video signal outputted from the VCR 101 is inputted to an input terminal 20 and supplied to the encoder 15. The encoder 15 converts the supplied video signal into a digital video signal by an A/D converting unit 15B. A compression encoding by, for example, an MPEG2 (Moving Pictures Experts Group 2) system is performed to the digital video signal by an MPEG encoder unit 15A and a resultant signal is outputted.

MPEG data obtained by compression encoding the video signal and outputting is supplied to the disk array 10 through the internal bus 11 and recorded. The disk array 10 has a plurality of hard disk drives (HDDS) 10A, 10B, 10C, 10D, and 10E. Those plurality of HDDs 10A to 10E operate in an interlocking manner on the basis of a control by an array controller (not shown). For example, RAID (Redundant Arrays of Inexpensive Disk) can be applied to the disk array 10.

The MPEG data stored in the disk array 10 is read out by an instruction from the CPU 12. The read-out MPEG data is supplied to the decoder 14. In the decoder 14, the supplied MPEG data is decoded by an MPEG decoder unit 14A so as to obtain a digital video signal, it is converted into an analog video signal by a D/A converting unit 14B, and the analog video signal is sent to an output terminal 21. The video signal outputted from the output terminal 21 is supplied to, for example, the monitor 106.

The CPU 12 controls the whole video server 100. An RAM (Random Access Memory) 13 is connected to the CPU 12. For example, arrangement information of the MPEG data stored in the disk array 10 is stored in the RAM 13. Although not shown, an ROM (Read Only Memory) in which a predetermined program and the like have previously been recorded is also connected to the CPU 12.

Remote interfaces 16 and 17 serving as interfaces for communication of transmission/reception data with the outside and for interruption of transmission and reception of such data are connected to the CPU 12. The remote (I/F)s 16 and 17 are connected to the host controller 105 and VCR 101, respectively, and make communication by, for example, RS-422.

A reference I/F 18 to which the reference signal from the reference signal generator 104 is inputted is connected to the CPU 12. The reference signal generated from the reference signal generator 104 is inputted to a reference signal input terminal 22 and supplied to the reference I/F 18. The reference I/F 18 supplies a reference interruption signal to the CPU 12 in response to the supplied reference signal.

In such a construction, for example, a remote command to instruct a predetermined operation is issued from the host controller 105 to the video server 100. The remote command is received by the remote I/F 16 and supplied to the CPU 12. The remote command is interpreted by the CPU 12 by a predetermined method. Each unit of the video server 100 is controlled by the CPU 12 on the basis of the interpretation.

Upon recording of the video signal, the host controller 105 generates a remote command for instructing in a manner such that a video tape loaded in the VCR 101 is reproduced and the video signal outputted from the VCR 101 is recorded into the disk array of the video server 100. This remote command is supplied from the host controller 105 to the video server 100.

The remote command received by the video server 100 is interpreted by the CPU 12 by a predetermined method. An instruction to start an encoding process is issued to the encoder 15 and the array controller (not shown) of the disk array 10 is instructed to record the MPEG data outputted from the encoder 15. At this time, on the basis of the arrangement information of the data on the disk array 10 stored in the RAM 13, it is instructed that an empty area in the disk array 10 is searched by the CPU 12 and the supplied MPEG data is recorded into the searched empty area. Upon completion of the recording of the MPEG data, the arrangement information of the data on the disk array 10 stored in the RAM 13 is updated.

A VCR command to control the VCR 101 is issued from the CPU 12 on the basis of the remote command supplied from the host controller 105. The VCR command is supplied to the VCR 101 through the remote I/F 17. The VCR 101 reproduces the loaded video tape on the basis of the VCR command and outputs the video signal. As mentioned above, the outputted video signal is inputted to the video server 100, supplied to the encoder 15, converted into digital video data, encoded by a predetermined method, and recorded into the disk array 10.

It is necessary that the encoding process which is executed by the encoder 15 is synchronized with the video signal outputted from the VCR 101, for example, on a frame unit basis. The video signal reproduced by the VCR 101 is synchronized with the process of the encoder 15 by the reference signal which is generated from the external reference signal generator 104 and supplied to both of the video server 100 and VCR 101. That is, the reference signal inputted through the reference signal input terminal 22 is received by the reference I/F 18 and supplied as a reference interruption signal to the CPU 12. The CPU 12 controls timing of the encoding process by the encoder 15 on the basis of the reference interruption signal.

When the video signal is reproduced, for example, a remote command to instruct to reproduce certain MPEG data from the MPEG data recorded in the disk array 10 is supplied from the host controller 105. This remote command is supplied to the video server 100 and received by the remote I/F 16. The remote command received by the remote I/F 16 is supplied to the CPU 12.

In the CPU 12, the received remote command is interpreted by a predetermined method and the recording position, in the disk array 10, of the MPEG data whose reproduction has been instructed is searched with reference to the arrangement information of the MPEG data recorded in the disk array 10. An instruction to access the recording position obtained as a result of the search is issued from the CPU 12 to the array controller (not shown) and, at the same time, an instruction to start a decoding process is issued to the decoder 14. The MPEG data read out and outputted from the disk array 10 is supplied to the decoder 14, decoded, and outputted.

During the reproduction of the MPEG data in the disk array 10, the access position in the disk array 10 is successively searched by the CPU 12. On the basis of the result of this search, an instruction to access the disk array 10 lest the video signal which is outputted from the decoder 14 is interrupted is issued from the CPU 12 to the array controller (not shown).

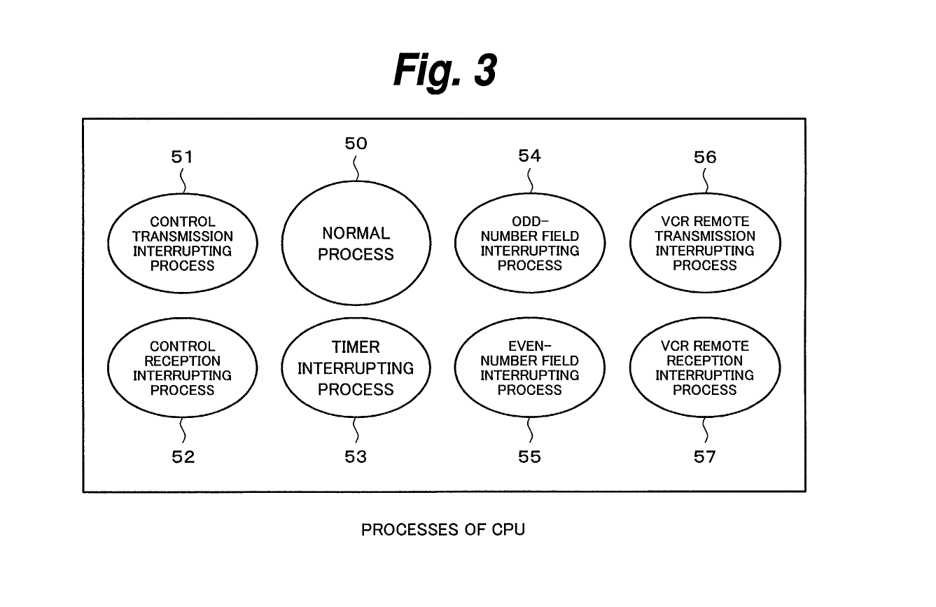

Processes in the CPU 12 of the video server 100 will be described. As shown in an example in FIG. 3, a normal process 50 and interrupting processes 51 to 57 which are executed by interrupting other processes are executed in the CPU 12. As interrupting processes, as shown in FIG. 3, there are a control transmission interrupting process 51, a control reception interrupting process 52, a timer interrupting process 53, an odd-number field interrupting process 54, an even-number field interrupting process 55, a VCR remote transmission interrupting process 56, and a VCR remote reception interrupting process 57.

The control transmission interrupting process 51 and control reception interrupting process 52 are made operative by the interruption from the remote I/F 16 for making serial communication with the host controller 105 by RS-422 or the like, and communication is made between the CPU 12 and host controller 105. Thus, a reception of the remote command transmitted from the host controller 105, a transmission of a status from the CPU 12 to the host controller 105, and the like are executed.

In the timer interrupting process 53, a communication time-out in each communication of the remote I/F 16 or 17 or the like is monitored and whether the reference signal (reference interruption signal) which is supplied from the reference I/F 18 is abnormal or not is monitored.

The VCR remote transmission interrupting process 56 and VCR remote reception interrupting process 57 are made operative by the interruption from the remote I/F 17 for making serial communication with the VCR 101. Thus, a reception and a transmission of the VCR command, the status of the VCR 101, and the like are executed between the VCR 101 and CPU 12.

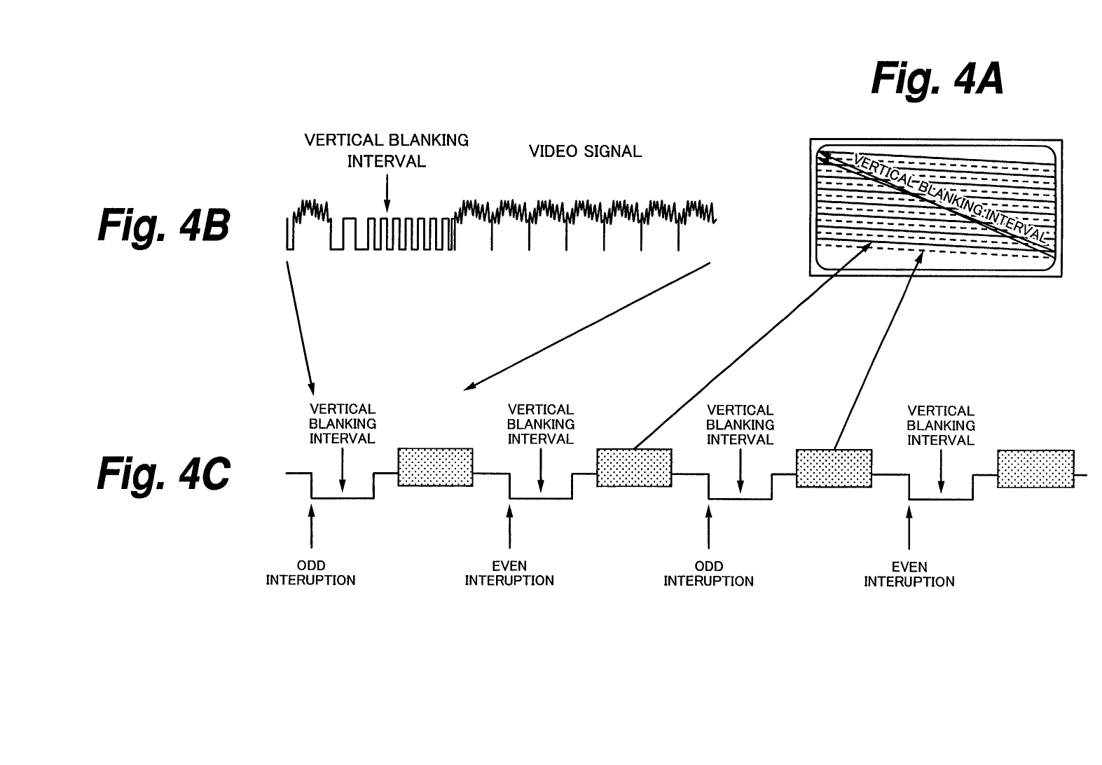

The odd-number field interrupting process 54 and even-number field interrupting process 55 will now be described with reference to FIGS. 4A to 4C. As is well-known, in case of the video signal of the interlace system, one frame is constructed by two fields: that is, a field comprising odd-number lines; and a field comprising even-number lines. Those two fields are alternately displayed and an image of one frame is displayed. An edition of the video signal is performed by using the frame as an edition unit. In case of the NTSC system, a frame frequency is set to about 30 Hz and a field frequency in which the odd-number fields and the even-number fields are combined is set to about 60 Hz.

For example, in case of displaying by a CRT (Cathode Ray Tube), as shown in FIG. 4A, when one of the fields is scanned to an end position (right edge of the last line) of the scan, a scanning position is returned to a start position (left edge of the head line) of the scan of the other field, and the scan of the other field is started. An interval where the scan is returned from the end position of the scan of one field to the start position of the scan of the other field is called a vertical blanking interval.

With respect to the video signal, actually, as shown in an example in FIG. 4B, a horizontal sync signal is inserted every line and a vertical sync signal is inserted to into the vertical blanking interval. When it is seen every field, as shown in FIG. 4C, in each field, the vertical blanking interval is arranged to the head and the video signal of each line in the field is arranged after that. Assuming that the first field is set to the odd-number (ODD) field and the second field is set to the even-number (EVEN) field, the odd-number field interrupting process 54 and even-number field interrupting process 55 to the CPU 12 are executed at a change point of each of the odd-number and even-number fields which are alternately arranged, that is, at head timing of the vertical blanking interval of each field.

A control of the VCR 101 will now be described. As mentioned above, the video server 100 and VCR 101 are connected by the serial communication via RS-422 or the like. By controlling the VCR 101 from the video server 100 by the serial communication, a predetermined video point on the video tape loaded into the VCR 101 is designated, the video tape is reproduced, and the reproduced video signal can be fetched into the video server 100. Thus, the video server 100 receives an encoding start time and an encoding end time on the VCR 101 from the host controller 105 and can perform the encoding by the encoder 15.

As is well-known, the video signal is constructed by setting the frame to the minimum unit and by sequentially updating the frame, a display of a motion image is realized. With respect to the frame, the image is constructed by 30 frames per second in the NTSC system and by 25 frames per second in the PAL system. Successive time information called time codes is recorded together with the video signal onto a recording medium, that is, a video tape which is used in the VCR 101. The time code is time information showing successive time in a range from 0:00 to 24:00 every frame. The time on the video tape is shown by the time code in a form of “hour: minute: second: frame”. By using the time code, a specific video image among the video images recorded on the video tape can be designated.

As mentioned above, the video server 100 and VCR 101 operate synchronously in response to the reference signal which is generated from the reference signal generator 104. The reference signal is a signal which changes at the start point of the field as shown in FIGS. 4A to 4C. The video apparatus such as video server 100 or VCR 101 allows the input/output timing of the video signal to correspond to the time by using the reference signal as a reference.

For example, in the video server 100, the reference signal generated from the reference signal generator 104 is received by the reference I/F 18 and supplied as a reference interruption signal to the CPU 12. On the basis of the supplied reference interruption signal, the CPU 12 generates an interruption signal for executing the odd-number field interrupting process and even-number field interrupting process mentioned above. Thus, the video server 100 can accurately know the change point of the time.

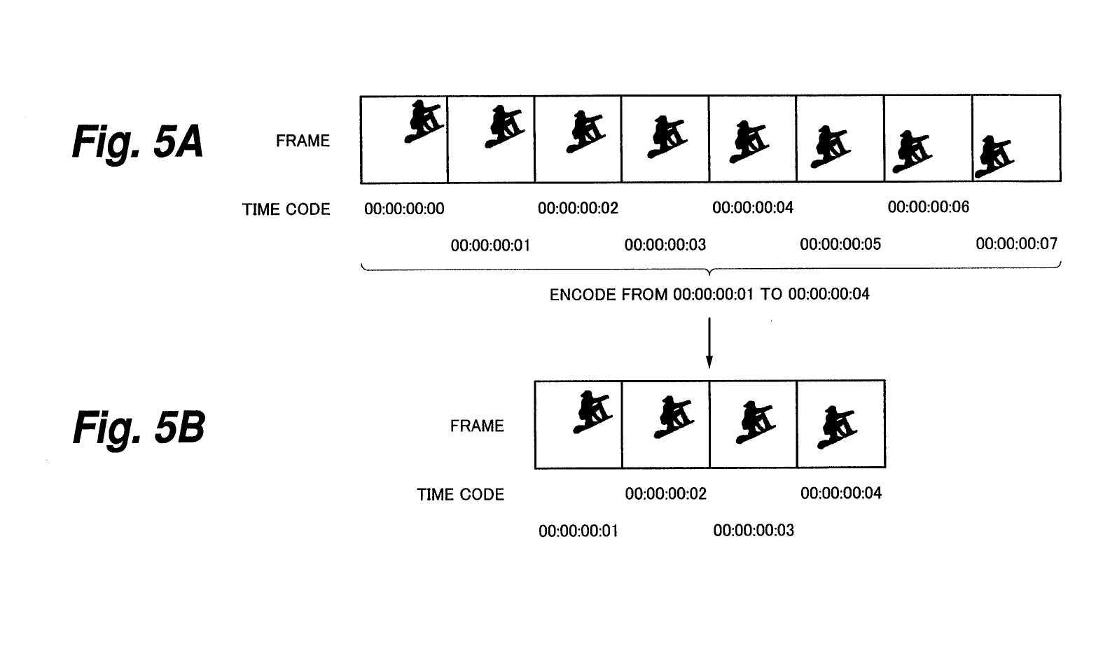

A method whereby the video signal which is reproduced and outputted from the video tape is encoded from the designated point will be schematically explained with reference to FIGS. 5A and 5B. There is considered a case where the VCR 101 is controlled from the video server 100 and, in the video signal recorded on the video tape loaded in the VCR 101 from the time code “00:00:00:00”, the video signal in a range from the time code “00:00:00:01” to the time code “00:00:00:04” is encoded as shown in FIG. 5B.

First, the video server 100 inquires of the VCR 101 about the present reproducing point on the video tape loaded in the VCR 101. As a result of the inquiry, if the encoding start point is located before the present reproducing point, an instruction to rewind the tape is issued from the video server 100 to the VCR 101. Similarly, as a result of the inquiry, if the encoding start point is located after the present reproducing point, an instruction to feed the tape is issued from the video server 100 to the VCR 101. By such an instruction, the rewinding or feeding of the tape is performed in the VCR 101.

Also while the rewinding or feeding of the tape is performed in the VCR 101, the video server 100 inquires of the VCR 101 about the time information of the tape, that is, the time code. The tape is fed to a position which is preceding to the encoding start point by, for example, a few seconds and the tape is paused at this position. For example, if the VCR 101 corresponds to a head search command called a queue-up, the queue-up command is used for instructing the pause. In the video server 100, a time which is required until the reproduced video image is stabilized when the VCR 101 is reproduced from the queue-up state is taken into consideration of. The queue-up is instructed to the VCR 101 at a time that is preceding to the encoding start time by a predetermined time.

Upon completion of the queue-up in the VCR 101, a reproducing command to instruct the reproduction of the video tape is issued from the video server 100 to the VCR 101. The video server 100 issues the reproducing command and, at the same time, inquires of the VCR 101 about the time information on the tape, that is, the time code. When the reproduction of the video tape is started in the VCR 101 and the time code on the tape reaches the encoding start point, in the video server 100, an instruction to start the encoding is issued from the CPU 12 to the encoder 15, so that the encoding is started.

During the encoding process, the video server 100 inquires of the VCR 101 about the time on the tape which is being reproduced in the VCR 101. When the reproducing time of the tape reaches the time designated so as to stop the encoding, in the video server 100, the CPU 12 issues an instruction to the encoder 15 to stop the encoding, so that the encoding is stopped.

The inquiry of the VCR 101 by the video server 100 is made with respect to not only the foregoing time information, that is, the time code but also the status as information indicative of each state of the VCR 101. By inquiring of the VCR 101 about the status, current information showing a current state of the VCR 101 at the inquiry time point can be obtained. As a current state of the VCR 101, there are a state where the tape cassette has been removed, are producing state, are production stop state, a reproduction pause state, a fast-forward feeding state, and the like.

The first embodiment of the invention will now be described. In the first embodiment, an inquiry period of the time information from the video server 100 to the VCR 101 is adjusted in accordance with the current state of the VCR 101. According to the first embodiment, the status of the VCR 101 is examined from the video server 100. If the current state of the VCR 101 is a state such that there is no need to consider the time code, the inquiry of the VCR 101 about the time information by the video server 100 is not made. As a state where the inquiry about the time information is unnecessary in the current state of the VCR 101, for example, there is a state where no tape cassette is loaded in the VCR 101 after the tape cassette was removed or the like or a stop state. Since there is no need to examine the time information on a frame unit basis when the fast-forward feeding or rewinding operation is executed in the VCR 101, an inquiry interval of the time information can be widened to an interval wider than that in the normal state. The examination of the status of the VCR 101 by the video server 100 is made at regular intervals.

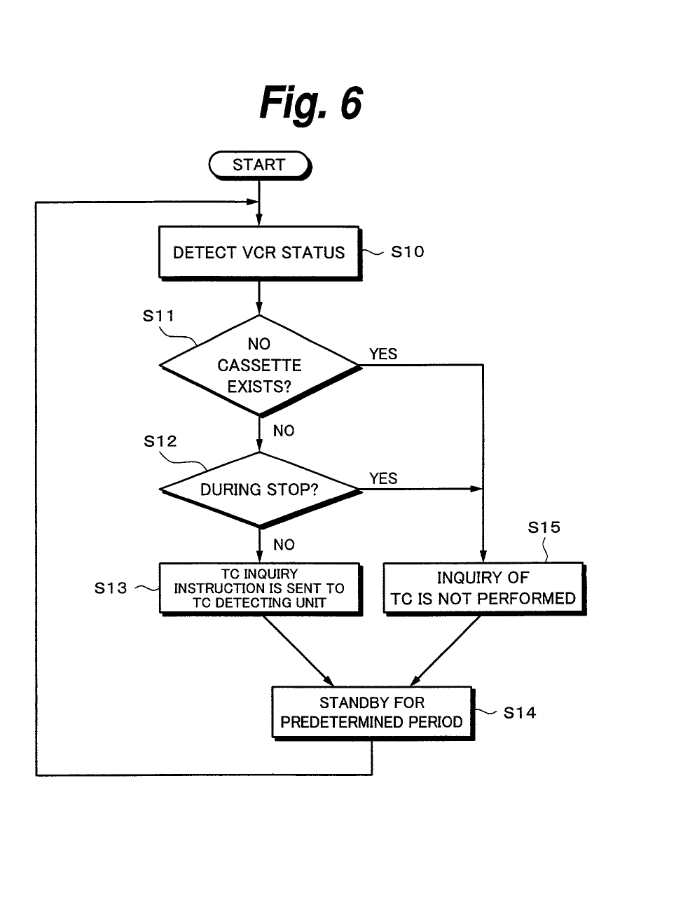

FIG. 6 is a flowchart of an example schematically showing processes in the video server 100 according to the first embodiment. In first step S10, the status of the VCR 101 is detected by the video server 100. In next step S11, whether the tape cassette has been loaded in the VCR 101 or not is discriminated on the basis of the status detected in step S10. If it is determined that the tape cassette has been loaded, the processing routine advances to step S12. Whether the operation of the video tape has been stopped in the VCR 101 or not is discriminated. If it is determined that the operation is not stopped, the processing routine advances to next step S13.

In step S13, an instruction to allow the video server 100 to inquiry of the VCR 101 about the time code is issued from the CPU 12 to a time code detecting unit (not shown) of the video server 100. The time code detecting unit communicates with the VCR 101 through the remote I/F 17 and obtains the time code on the VCR 101. The obtained time code is supplied to the CPU 12.

If the instruction to make an inquiry about the time code is issued in step S13, the processing routine advances to step S14 and the apparatus waits for a predetermined period. The processing routine is returned to step S10.

If it is determined in step S11 that the tape cassette is not loaded in the VCR 101 or if it is decided in step S12 that the VCR 101 has been stopped, the processing routine advances to step S15. The detection of the time code is not performed. The processing routine advances to step S14.

In the process in step S13 mentioned above, the inquiry interval of the time code can be set by a predetermined method in accordance with the contents of the status of the VCR 101 detected in step S10. For example, if the contents of the status indicate the fast-forward feeding or rewriting operation, the inquiry interval of the time code is set to a few seconds.

In the process in step S15, if no tape cassette is loaded in the VCR 101 and if the VCR 101 has been stopped, the inquiry of the VCR 101 about the time code by the video server 100 is not made. However, the invention is not limited to such an example. For instance, the time code can be also inquired at regular intervals of a few seconds.

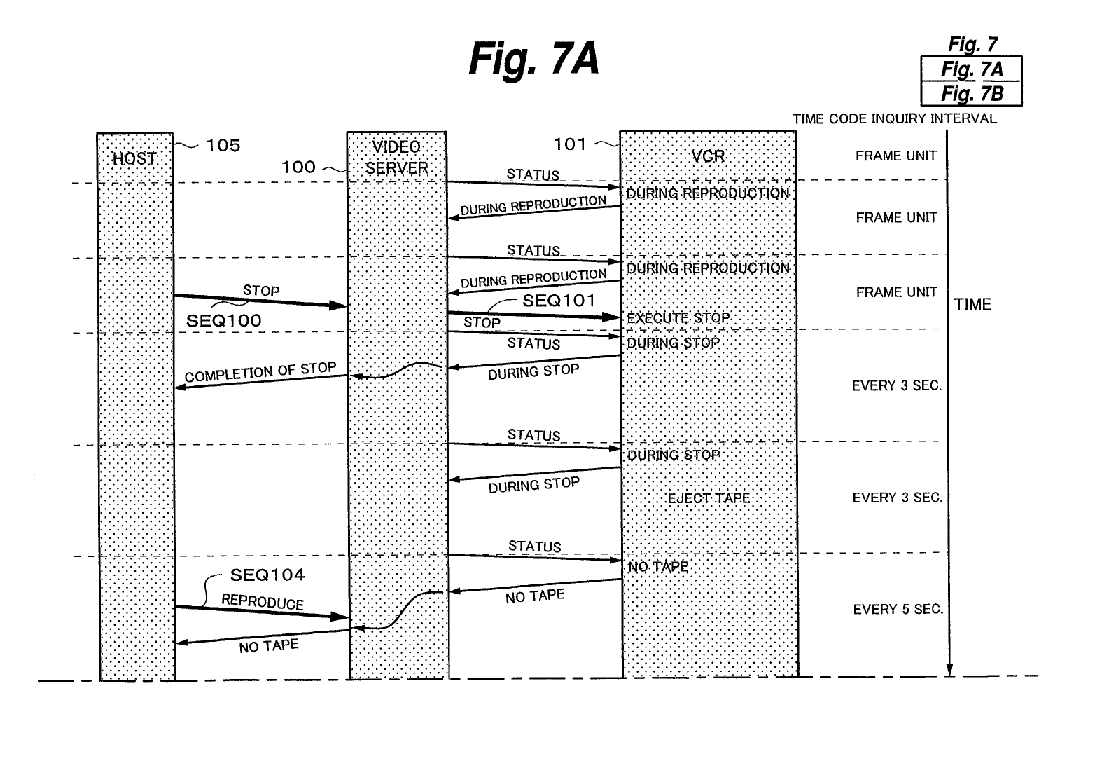

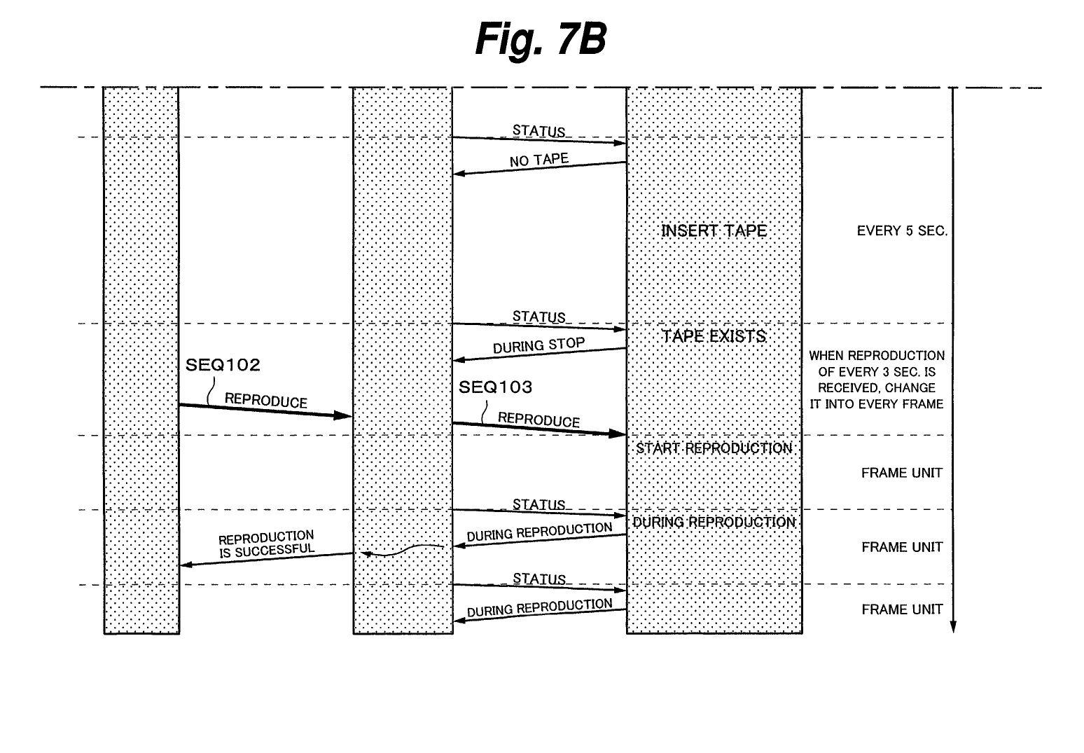

FIGS. 7A and 7B show an example of the inquiry interval of the time information to the VCR 101 from the video server 100 in each current state of VCR 101. If the video tape is being reproduced in the VCR 101, the time code is inquired on a frame unit basis.

As shown in sequences SEQ 100 and SEQ 101 in FIGS. 7A and 7B, when a reproduction stop instruction of the VCR 101 is issued from the host controller 105 to the video server 100 and the reproduction stop is instructed from the video server 100 to the VCR 101 on the basis of the reproduction stop instruction, the reproduction of the video tape is stopped in the VCR 101. The inquiry interval of the time code is set to a wide interval such as 3 seconds. When the reproduction of the video tape is stopped and the video cassette is removed from the VCR 101, a status indicative of this fact is detected by the video server 100. The inquiry interval of the time code is set to a further wide interval such as 5 seconds. When the tape cassette is loaded into the VCR 101 and this fact is detected by the status detection of the video server 100, the inquiry interval of the time code is set to the value at the time of the stop of the reproduction, that is, 3 seconds as mentioned above.

On the other hand, as shown in sequences SEQ 102 and SEQ 103 in FIGS. 7A and 7B, when are production instruction to the VCR 101 is issued from the host controller 105 to the video server 100 and if it is determined on the basis of the detected status that the current state of the VCR 101 is the state where the tape cassette has been loaded, the reproduction is instructed from the video server 100 to the VCR 101 on the basis of this instruction. The reproduction of the video tape is started in the VCR 101 in response to such an instruction. The inquiry interval of the time code is changed from 3 seconds as a value upon stop of the reproduction to a frame unit as a value upon reproduction.

When the reproduction of the video tape is started in the VCR 101, this fact is detected by the status detection of the video server 100. The host controller 105 which instructed the reproduction is notified of a detection result.

As shown in a sequence SEQ 104 in FIGS. 7A and 7B, in a state where no tape cassette is loaded in the VCR 101, there is a case where the reproduction in the VCR 101 is instructed from the host controller 105 to the video server 100. As mentioned above, the status of the VCR 101 is detected at regular intervals in the video server 100. Thus, the video server 100 notifies the host controller 105 of a message indicative of the fact that no tape cassette is loaded in the VCR 101.

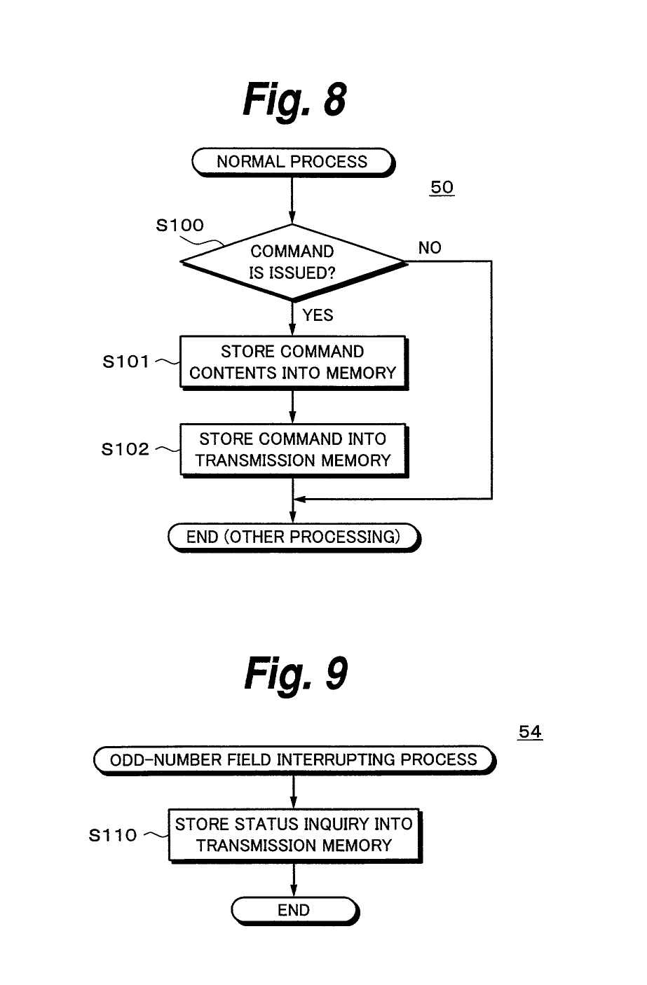

FIGS. 8 to 13 show a detailed example of each of the interrupting processes mentioned above with reference to FIG. 3. An inquiry adjustment of the time code to the VCR 101 will now be described with reference to FIGS. 8 to 13.

FIG. 8 shows the normal process 50. In the normal process 50, whether a command is issued from the video server 100 to the VCR 101 or not is discriminated in step S100. For example, the reproducing instruction of the video tape by the VCR 101 which was issued from the host controller 105 to the video server 100 is received by the video server 100. On the basis of this instruction, the reproducing command to instruct the reproduction is issued from the video server 100 to the VCR 101.

If the reproducing command is issued, contents of the command are stored into a memory such as an RAM 13 in next step S101. The command is stored into a transmission memory in step S102. The transmission memory is, for example, a memory which is provided for the remote I/F 17 for making communication between the video server 100 and VCR 101.

In the odd-number field interrupting process 54 shown in FIG. 9, in step S110, the status inquiry command which is issued from the video server 100 to the VCR 101 is stored into the transmission memory.

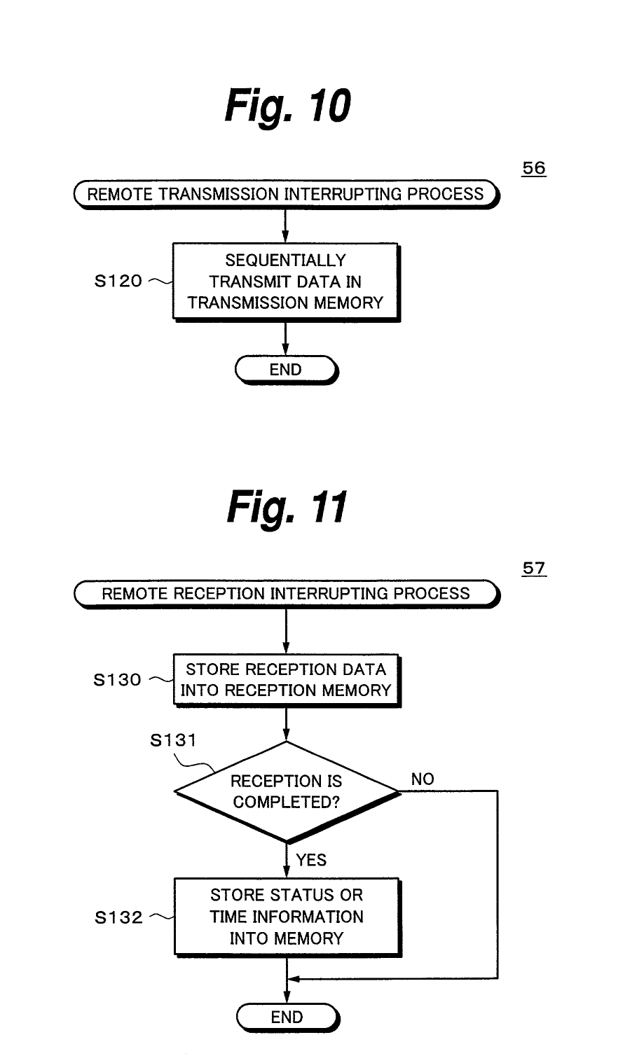

In the VCR remote transmission interrupting process 56 shown in FIG. 10, in step S120, the data stored in the transmission memory in steps S102 and S110 mentioned above is sequentially transmitted.

In the VCR remote reception interrupting process 57 shown in FIG. 11, in step S130, the data received from the VCR 101 is stored into a reception memory. The reception memory is, for example, a memory which is provided for the remote I/F 17 for making communication between the video server 100 and VCR 101. In step S131, when the data reception from the VCR 101 in step S130 is completed, the data stored in the reception memory, that is, the status and the time information of the VCR 101 which were transmitted from the VCR 101 are stored into a memory such as an RAM 13 or the like in step S132.

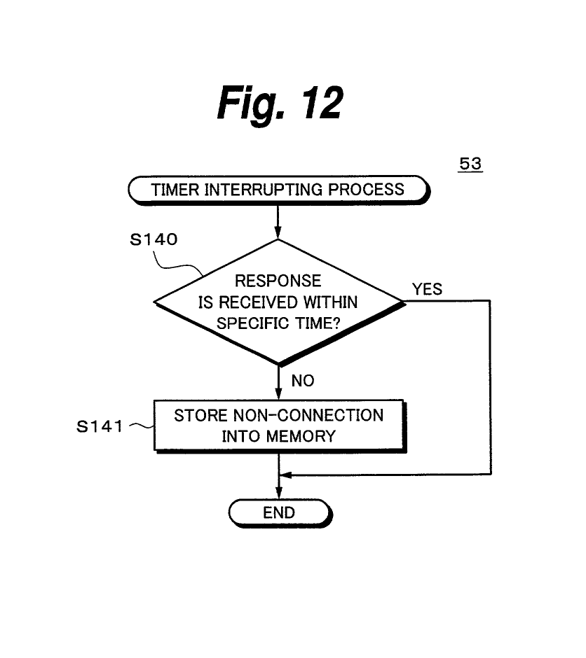

In the timer interrupting process 53 shown in FIG. 12, for example, when the communication is made from the video server 100 to the VCR 101 as shown in the process in step S120 mentioned above, whether a reply from the VCR 101 has been received within a specific time or not is discriminated in step S140. If the reply from the VCR 101 has been received within the specific time, the processing routine advances to other processing. If it is decided that the reply from the VCR 101 is not received within the specific time, it is determined that the VCR 101 is not connected to the video server 100. This fact is stored into a memory such as an RAM 13 or the like. If the non-connection state has been stored into the memory, the processing routine advances to other processing.

It is determined that the VCR 101 is not connected in the case where the video server 100 and VCR 101 are not connected by the control cable 103, a case where a power source of the VCR 101 is not turned on, or the like.

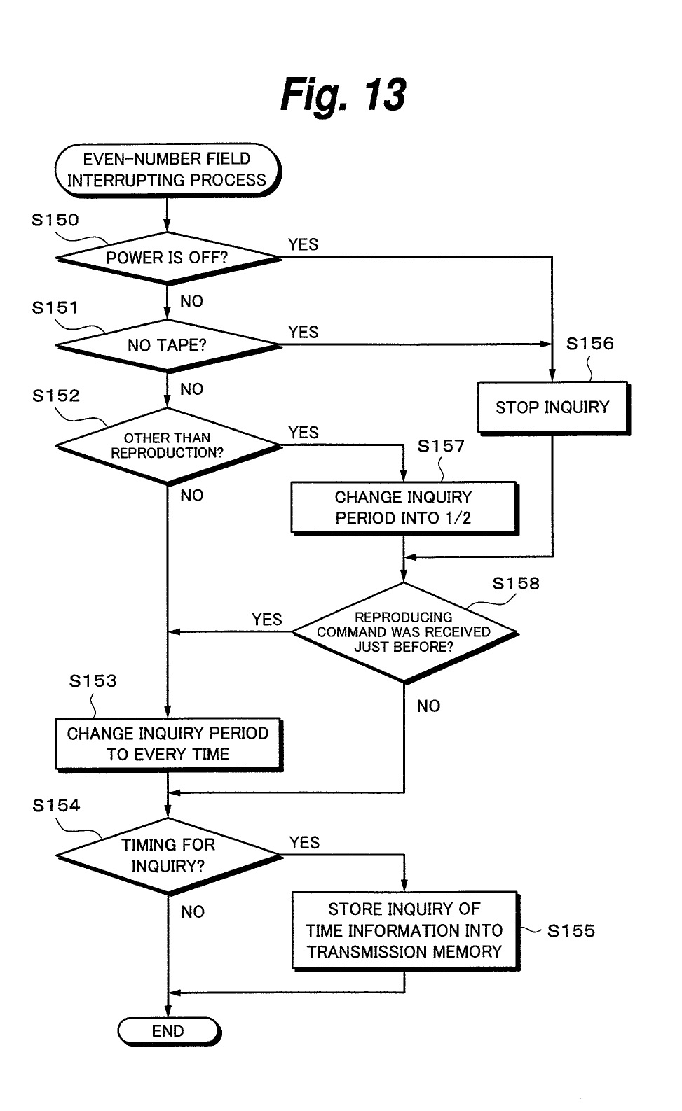

In the even-number field interrupting process 55 shown in FIG. 13, in first step S150, whether the power source of the VCR 101 is OFF or not is discriminated. This discrimination in step S150 is made on the basis of the information stored in the memory by the process in step S141 in FIG. 12 mentioned above.

If it is determined in step S150 that the power source of the VCR 101 is not OFF, whether the tape cassette has been loaded in the VCR 101 or not is discriminated in next step S151. If it is determined in step S151 that the tape cassette has been loaded in the VCR 101, the processing routine advances to next step S152. Whether the current state of the VCR 101 is other than the reproducing mode or not is discriminated. The discrimination in steps S151 and S152 is made on the basis of the status information of the VCR 101 stored in the memory by the process in step S132 in FIG. 11 mentioned above.

If it is determined in step S152 that the current state of the VCR 101 is the reproducing mode, the inquiry interval about the time information which is inquired of the VCR 101 by the video server 100 is set to the frame interval in step S153. In next step S154, whether the present time is the timing for inquiring of the VCR 101 about the time information or not is discriminated. If it is decided that the present time is not the inquiry timing, the even-number field interrupting process 55 is finished.

If it is decided in step S154 that the present time is the inquiry timing, step S155 follows. In step S155, the inquiry command about the time information to the VCR 101 is stored into the transmission memory. The inquiry command about the time information to the VCR 101 which was stored in the transmission memory is sequentially transmitted by the process in step S120 in the flowchart of FIG. 10 mentioned above.

If it is decided in step S150 that the power source of the VCR 101 is OFF and if it is determined in step S151 that no tape cassette is loaded in the VCR 101, step S156 follows. The inquiry of the VCR 101 about the time information is stopped. The processing routine advances to step S158, which will be explained herein later.

If it is determined in step S152 that the current state of the VCR 101 is other than the reproducing mode, step S157 follows. In step S157, an inquiry period about the time information to the VCR 101 is set to ½, that is, a period of every two frames, and step S158 follows.

In step S158, whether the video server 100 has received the reproducing command just before or not is discriminated. This discrimination is made on the basis of the process in step S101 in the flowchart of the normal process 50 shown in FIG. 8 mentioned above by referring to the contents in the memory in which the command is stored. If it is determined in step S158 that the video server 100 has received the reproducing command just before, the processing routine advances to step S153. The inquiry period about the time information to the VCR 101 is set to the frame period.

If it is decided in step S158 that the video server 100 does not receive the reproducing command just before, the processing routine advances to step S154.

The second embodiment of the invention will now be described. According to the second embodiment, the time information in the VCR 101 is presumed, thereby reducing the number of times of inquiry of the VCR 101 about the time information by the video server 100. The normal process and the interrupting processes 51 to 54, 56, and 57 in the CPU 12 in the second embodiment are common to those in the first embodiment mentioned above.

After the queue-up just before the start of the encoding and during the encoding operation, the accurate time information is necessary for the encoder 15. In the VCR 101, therefore, the time information is necessary only during the reproduction. Usually, since the video images to be subjected to the encoding are successive, a count value obtained by counting the number of frames of the video signal supplied for the encoding on the video server 100 side for encoding can be used as time information.

As already mentioned, the minimum unit of the time information, that is, the time code in the VCR 101 is the frame, and the counter is counted up by a frame pulse indicative of a change point of the frame. The reference signal generated from the reference signal generator 104 is supplied to both of the video server 100 and the VCR 101. By measuring the reference signal, the time information in the VCR 101 can be presumed by the video server 100.

A situation such that discontinuous points of the time information exist on the video tape is also considered. Therefore, the VCR 101 is inquired about the time information at a relatively long interval. The time information presumed by the video server 100 is corrected by using the time information obtained by the inquiry. By this method, even if the discontinuous points of the time information exist in the video signal which is reproduced by the VCR 101, it is possible to cope with such a situation.

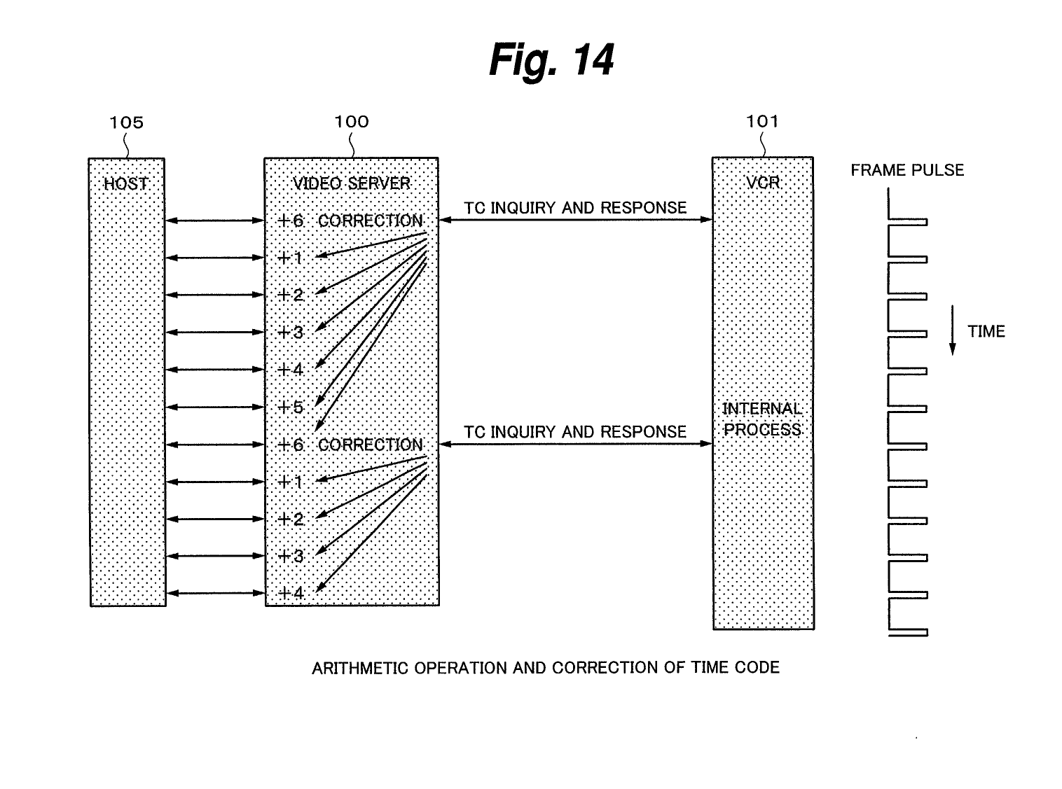

FIG. 14 schematically shows an arithmetic operation and a correction of the time information according to the second embodiment. In the example of FIG. 14, the video server 100 inquires of the VCR 101 about the time information every period of 6 frames on the basis of the frame pulses. The video server 100 inquires of the VCR 101 about the time information and a reply to the inquiry is returned from the VCR 101 to the video server 100. In the video server 100, the current time information in the video server 100 is corrected on the basis of the time information obtained by the inquiry.

The frame pulses which are used when the time information is corrected are set to a reference and the time information which was incremented by one frame every frame pulse is added to the corrected time information every frame pulse. Thus, in the video server 100, the time information is presumed by using the corrected time information. The presumed time information is used in the video server 100.

When the period of 6 frames elapses, the video server 100 inquires of the VCR 101 about the time information again. The time information of the video server 100 is corrected by using the time information of the VCR 101 obtained as an inquiry result. According to the second embodiment, the inquiring process of the time information is omitted as mentioned above.

The encoding process by the encoder 15 is executed on the basis of the corrected time information and the presumed time information. Similarly, the corrected time information and the presumed time information are transmitted and received between the host controller 105 and video server 100.

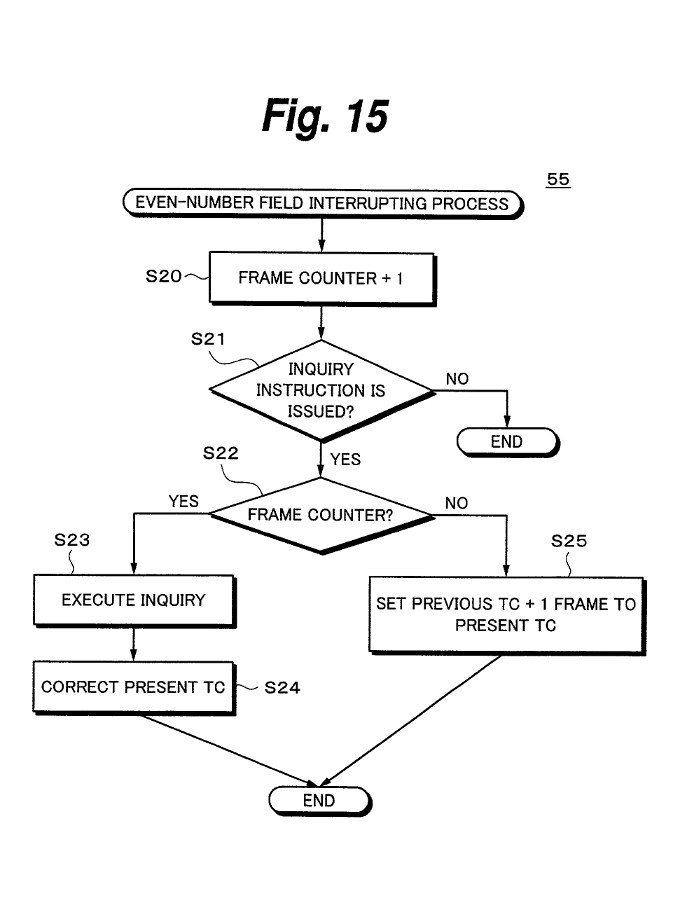

FIG. 15 is a flowchart showing processes of an example of the arithmetic operation and correction of the time information according to the second embodiment. This flowchart relates to an example in case of inquiring of the VCR 101 about the time information once per 10 frames. The processes according to the flowchart of FIG. 15 are executed as an even-number field interrupting process 55 every even-number field. In first step S20, the count value of the frame counter for counting the number of frames is increased by “1”.

In next step S21, whether the instruction to inquire of the VCR 101 about the time information (TC: time code) has been issued or not is discriminated. If the inquiry instruction about the time information is not issued, the processes in this field are finished. If the inquiry instruction has been issued, the processing routine advances to step S22.

In step S22, whether the count value of the frame counter has exceeded a predetermined value, for example, 10 or not is discriminated. If it is determined that the count value of the frame counter has exceeded the predetermined value, step S23 follows. The video server 100 inquires of the VCR 101 about the time information. By using the time information obtained as an inquiry result, the current time information in the video server 100 is corrected in next step S24. When the time information is corrected, the processes in this field are finished.

The count value of the frame counter is reset in step S23 or S24 mentioned above.

If it is determined in step S22 that the count value of the frame counter does not exceed the predetermined value, step S25 follows. The value obtained by adding the value of one frame to the previous time information is set to the current time information. When the current time information is updated, the processes in this field are finished.

The time information in the video server 100 is once converted into binary data, incremented after that, and converted again into the time information. In case of the video signal of the NTSC system, a drop frame is applied in order to correct a deviation between the real time and the time code. It is desirable to correct the time information in the video server 100 by using the drop frame.

The processes according to the second embodiment and those according to the first embodiment can be interlocked. That is, the time information in the VCR 101 is inquired at predetermined intervals, the status information of the VCR 101 is inquired by a predetermined method, and the current state of the VCR 101 such that there is no need to inquire about the time information as in a case where no tape cassette is loaded in the VCR 101, during the stop of the VCR 101, or the like is detected. If it is determined as a detection result that the current state of the VCR 101 is the state such that there is no need to inquire of the VCR 101 about the time information, it is prevented that the video server 100 inquires of the VCR 101 about the time information.

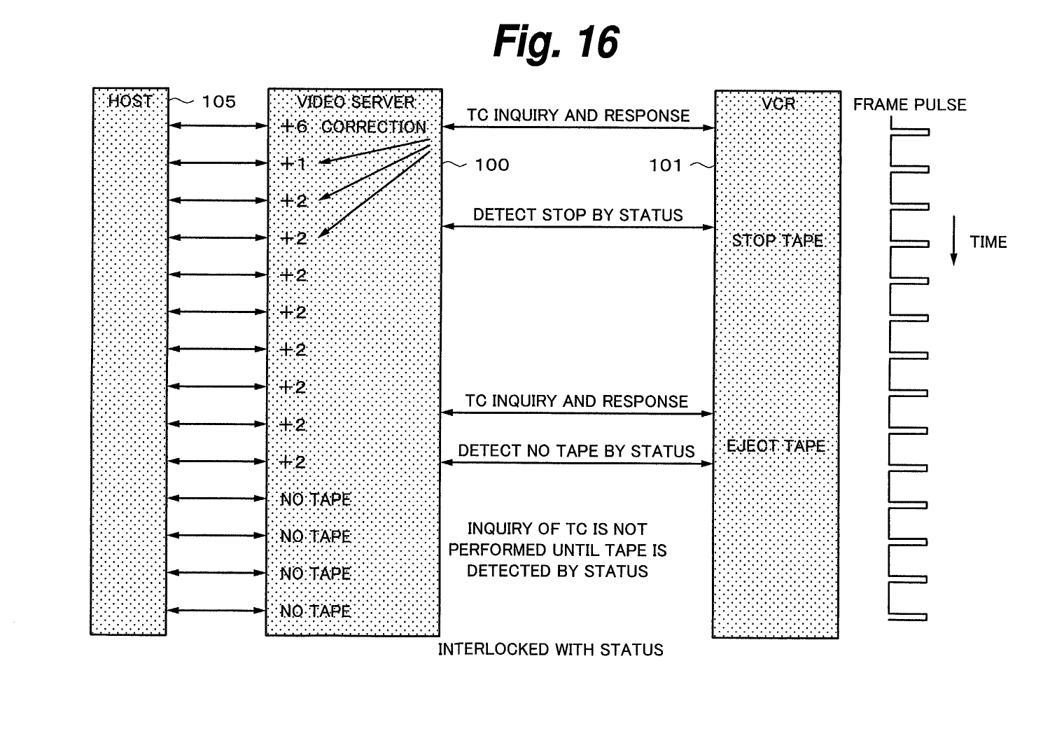

FIG. 16 schematically shows the processes in the case where the inquiry about the status information and the inquiry about the time information have been interlocked as mentioned above. The video server 100 inquires of the VCR 101 about the status at predetermined intervals, for example, every several frames. After the VCR 101 was inquired about the time information, the correction and presumption of the time information in the video server 100 based on the time information obtained by the inquiry are executed in accordance with the foregoing second method.

The video server 100 inquires of the VCR 101 about the status information. If the current state of the VCR 101 is, for example, the stop state as a result of the inquiry, the time information which is added to the corrected time information at the point when the status has been detected is held until the status is changed. In the example shown in FIG. 16, the status such that the current status of the VCR 101 indicates that no tape cassette is loaded in the VCR 101 is obtained upon inquiry about the next status. From this time point, the inquiry of the VCR 101 about the time information by the video server 100 is stopped. Until the status showing that the tape cassette has been loaded in the VCR 101 is detected, the inquiry of the VCR 101 about the time information by the video server 100 is not made.

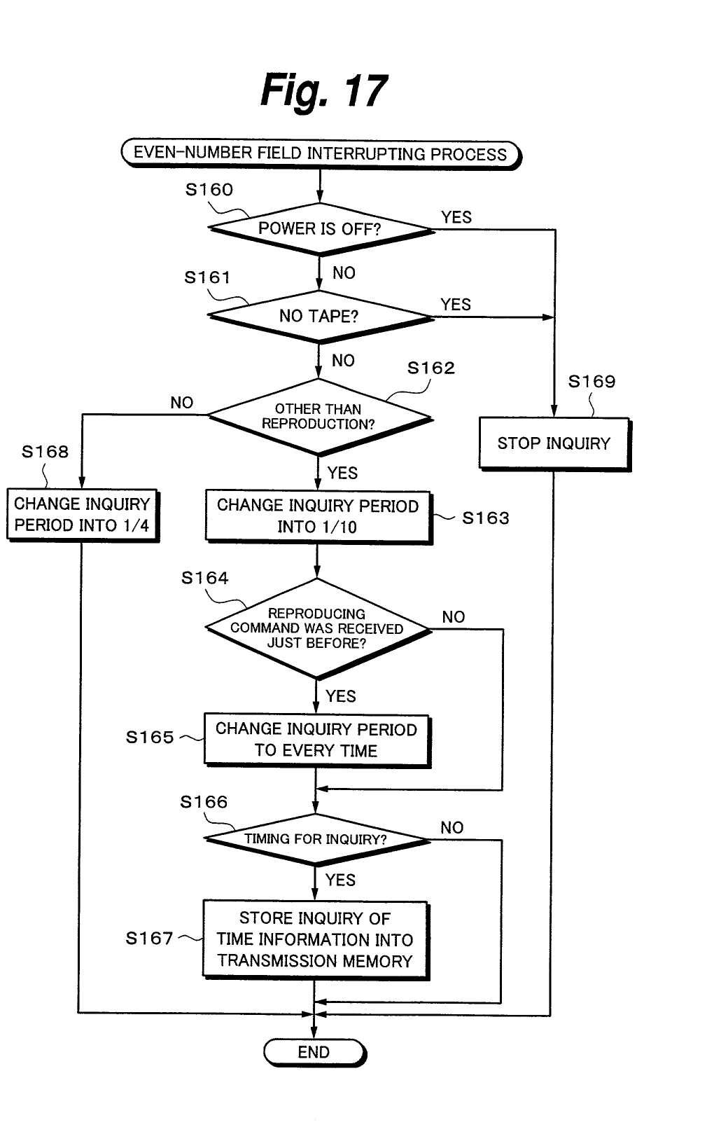

FIG. 17 is a flowchart showing an example of processes in the case where the inquiry about the status and the inquiry about the time information have been interlocked as mentioned above. Those processes are executed as an even-number field interrupting process 55. In first step S160, whether the power source of the VCR 101 is OFF or not is discriminated.

In step S160, if it is determined that the power source of the VCR 101 is not OFF, whether the tape cassette has been loaded in the VCR 101 or not is discriminated in next step S161. If it is determined in step S161 that the tape cassette has been loaded in the VCR 101, the processing routine advances to next step S162. Whether the current state of the VCR 101 is other than the reproducing mode or not is discriminated.

Instep S162, if it is determined that the current state of the VCR 101 is other than the reproducing mode, in step S163, the inquiry period of the inquiry of the VCR 101 about the time information which is made by the video server 100 is set to, for example, 1/10 of the frame period. That is, it is set so that the inquiry about the time information is made every period of 10 frames.

In next step S164, whether the video server 100 has received the reproducing command just before or not is discriminated. If it is decided that the video server 100 does not receive the reproducing command just before, the processing routine advances to step S166, which will be explained herein later.

If it is decided in step S164 that the video server 100 has received the reproducing command just before, step S165 follows. The inquiry period is set so that the video server 100 inquires of the VCR 101 about the time information every frame, and the inquiry period about the time information is set to the frame period.

In next step S166, whether the present time is timing for inquiring of the VCR 101 about the time information or not is discriminated. If it is decided that the present time is not the inquiry timing, the even-number field interrupting process 55 is finished.

If it is determined in step S166 that the present time is the inquiry timing, the processing routine advances to step S167. In step S167, the command to inquire of the VCR 101 about the time information is stored into the foregoing transmission memory. The inquiry command about the time information to the VCR 101 which was stored in the transmission memory is sequentially transmitted by the process in step S120 in the flowchart of FIG. 10 mentioned above.

If it is decided in step S160 that the power source of the VCR 101 is OFF and if it is determined in step S161 that the tape cassette is not loaded in the VCR 101, the processing routine advances to step S169 and the inquiry of the VCR 101 about the time information is stopped. The even-number field interrupting process is finished.

If it is decided in step S162 that the current state of the VCR 101 is the reproducing mode, the processing routine advances to step S168. In step S168, the inquiry period of the time information to the VCR 101 is set to ¼, that is, a period of every 4 frames. The even-number field interrupting process is finished.

The third embodiment of the invention will now be described. The third embodiment relates to the processes in each frame period. In the third embodiment, the processes of each frame are common to those in the first and second embodiments mentioned above.

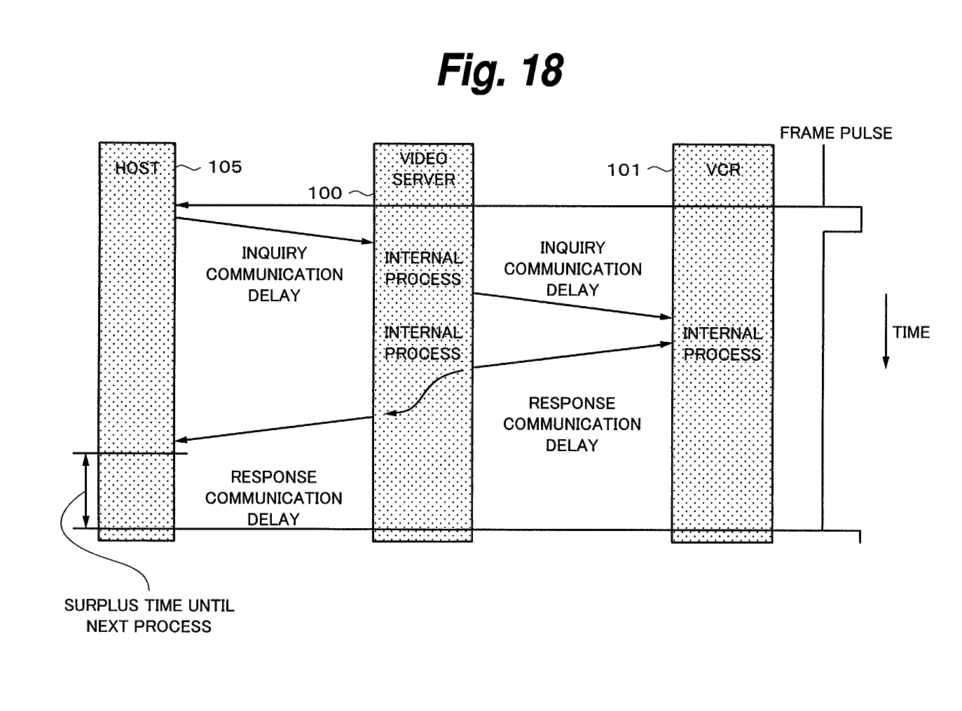

For example, a case where the inquiry of the VCR 101 which is made by the host controller 105 through the video server 100 is made synchronously with the frame pulse will now be considered. In this case, as shown in an example in FIG. 18, a delay is caused in the communication between the host controller 105 and video server 100 and a delay is caused in the communication between the video server 100 and VCR 101, respectively. In the video server 100 and VCR 101, a time necessary for the internal processes is expended and a delay is caused, respectively. Thus, the reply to the inquiry outputted from the host controller 105 is delayed by the time corresponding to the above delay and returned to the controller 105.

Therefore, in the host controller 105, in order to obtain the reply to the inquiry regarding the VCR 101 which was made by the video server 100 synchronously with a certain frame pulse, the internal processing time corresponding to the reciprocation of the video server 100, the communicating time of the reciprocation in a range from the video server 100 to the VCR 101, and the internal processing time in the VCR 101 are required. The time obtained by subtracting the sum of those times from the 1-frame pulse period becomes a surplus time until the next process in the host controller 105.

On the other hand, in the third embodiment, with respect to an application such that the time information is necessary in the host controller 105, the time information and status information of the VCR 101 which were held in the video server 100 are referred to at the reception timing of the command outputted from the host controller 105 to the video server 100. The present status of the VCR 101 is presumed. The presumed status is returned from the video server 100 to the host controller 105 as a status corresponding to the current state of the VCR 101.

The time information of the VCR 101 obtained as shown in the foregoing second embodiment is stored into the memory such as an RAM 13 of the video server 100. When the inquiry of the VCR 101 about the time information is instructed from the host controller 105 to the video server 100, the time information stored in the RAM 13 is read out and returned to the host controller 105 as time information of the inquired VCR 101. Thus, the time information of the VCR 101 can be returned to the host controller 105 without inquiring of the VCR 101 about the time information.

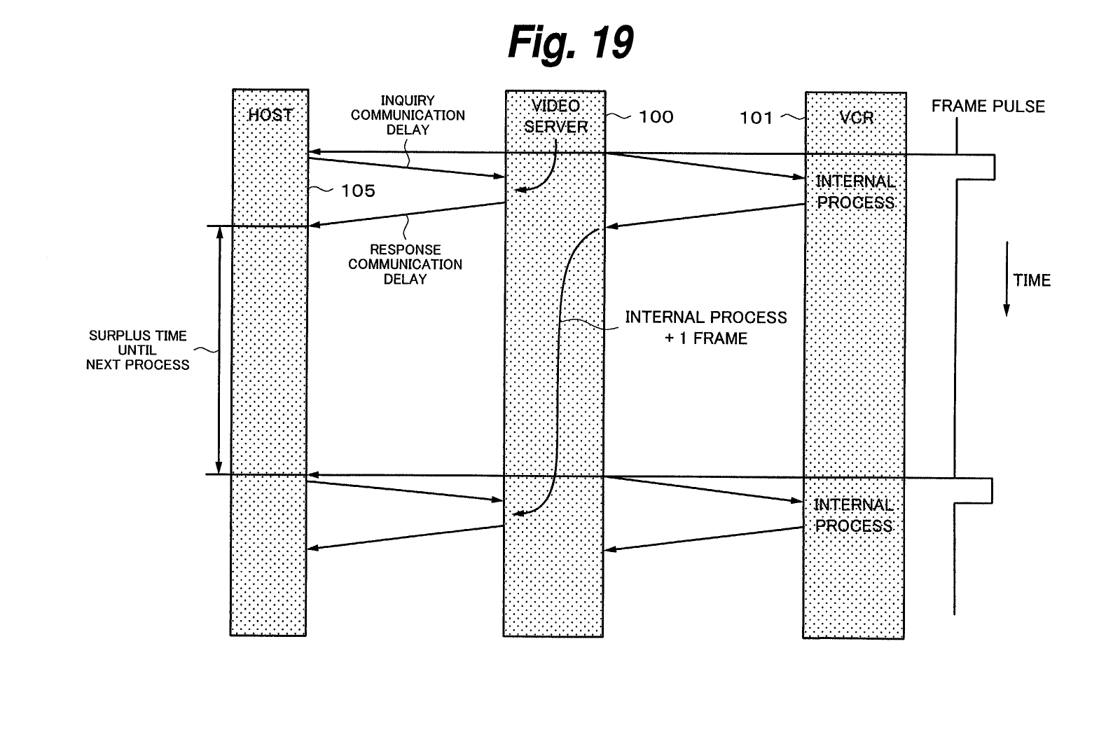

FIG. 19 schematically shows processes in the frame period according to the third embodiment. The reply to the inquiry of the VCR 101 about the time information, status, and the like which was sent from the host controller 105 to the video server 100 is directly returned from the video server 100 to the host controller 105. Therefore, in the host controller 105, the time which is required for the replay to the inquiry regarding the VCR 101 which was made from the host controller 105 to the video server 100 can be reduced. The surplus time until the next process which is fairly longer than that in the example of FIG. 18 mentioned above can be assured.

The information which is responded from the video server 100 in response to the inquiry by the host controller 105 is based on the processes which were executed between the video server 100 and VCR 101 at the timing that is preceding by at least one frame.

Although the video signal source for supplying the video signal to the video server 100 is the VCR 101 for reproducing the video tape enclosed in the tape cassette in the above embodiments, the invention is not limited to such an example. The video signal source can be also a disk reproducing apparatus for reproducing an optical disk or a disk recorder for recording video data onto a hard disk. Another video server can be also used as a video signal source.

The foregoing first, second, and third embodiments can be also combined and executed.

As described above, according to the first embodiment of the invention, when the current state of the VCR is a state where there is no need to consider the time code like a case where no tape cassette is loaded in the VCR, a case where the VCR is stopped, or the like, the video server does not inquire of the VCR about the time code. There is, consequently, an effect such that a load of the communication in the video server is reduced.

According to the second embodiment of the invention, the time code of the VCR is inquired at predetermined intervals, the time code in the video server is corrected, and the time code is incremented every frame pulse for the corrected time code, thereby presuming the time code of the VCR. Thus, there is an effect such that a load of the communication in the video server is reduced.

There is, consequently, an effect such that the CPUs which are used in the video server can be selected without much consideration to the communication load and the costs can be suppressed.

Further, since the communication load in the video server is reduced, there is an effect such that the number of CPUs which are used can be reduced in dependence on the construction of the video server and it is advantageous in terms of the costs.

Moreover, since the communication load is reduced and the number of communication times is decreased, there is an effect such that the electric power consumption of the video server itself can be suppressed.

According to the third embodiment of the invention, when the host controller inquires of the VCR about the time information and status of the VCR through the video server, the reply to the host controller is directly returned from the video server on the basis of the information stored in the video server. Therefore, the delay due to the communication and the internal process in each apparatus is small. There is an effect such that the sufficient processing time in the host controller can be assured.

The present invention is not limited to the foregoing embodiments but many modifications and variations are possible within the spirit and scope of the appended claims of the invention.

What is claimed is:

1. A video server which can accumulatively record a video signal reproduced by a video signal reproducing apparatus, comprising:
communicating means for communicating with said video signal reproducing apparatus which reproduces and outputs the video signal on the basis of time information corresponding to an edition unit of said video signal;
control means for allowing said communicating means to communicate with said video signal reproducing apparatus, obtaining said time information on said video signal reproducing apparatus, and controlling said video signal reproducing apparatus so as to reproduce the video signal on the basis of said time information;
video signal processing means for performing a predetermined process on the basis of said time information to said video signal outputted from said video signal reproducing apparatus on the basis of the control by said control means; and
recording means for recording said video signal subjected to said predetermined process by said video signal processing means,
wherein said control means obtains said time information on said video signal reproducing apparatus at a period longer than said edition unit.

2. A server according to claim 1, wherein said control means allows said communicating means to make the communication, obtains a current state of said video signal reproducing apparatus, and sets said period for obtaining said time information from said video signal reproducing apparatus in accordance with said obtained current state.

3. A server according to claim 1, further comprising reference signal receiving means for receiving a reference signal which is shared by said video signal reproducing apparatus,
and wherein said control means presumes said time information on said video signal reproducing apparatus on said edition unit basis
by using said time information on said video signal reproducing apparatus obtained by making the communication by said communicating means and said reference signal received by said reference signal receiving means.

4. A server according to claim 1, further comprising:
another communicating means for communicating with a host controller;
memory means for holding said time information on said video signal reproducing apparatus which was obtained by making the communication by said communicating means; and
reference signal receiving means for receiving a reference signal which is shared by said video signal reproducing apparatus,
and wherein when said time information on said video signal reproducing apparatus is requested from said host controller through said another communicating means, said control means directly responds to said host controller on the basis of said time information held in said memory means without allowing said communicating means to communicate with said video signal reproducing apparatus.

5. A server according to claim 4, wherein
a current state on said video signal reproducing apparatus which was obtained by making the communication by said communicating means is further held in said memory means, and
when said time information on said video signal reproducing apparatus is requested from said host controller through said another communicating means, said control means directly responds to said host controller on the basis of said current state and said time information held in said memory means without allowing said communicating means to communicate with said video signal reproducing apparatus.

6. A control apparatus for controlling a reproduction of a video signal by a video signal reproducing apparatus on the basis of time information, comprising:
communicating means for communicating with said video signal reproducing apparatus which reproduces and outputs the video signal on the basis of said time information corresponding to an edition unit of said video signal; and
control means for allowing said communicating means to communicate with said video signal reproducing apparatus, obtaining said time information on said video signal reproducing apparatus, and controlling said video signal reproducing apparatus so as to reproduce the video signal on the basis of said time information,
wherein said control means obtains said time information on said video signal reproducing apparatus at a period longer than said edition unit.

7. An apparatus according to claim 6, wherein said control means allows said communicating means to make the communication, obtains a current state of said video signal reproducing apparatus, and sets said period for obtaining said time information from said video signal reproducing apparatus in accordance with said obtained current state.

8. An apparatus according to claim 6, further comprising reference signal receiving means for receiving a reference signal which is shared by said video signal reproducing apparatus,
and wherein said control means presumes said time information on said video signal reproducing apparatus on said edition unit basis
by using said time information on said video signal reproducing apparatus obtained by making the communication by said communicating means and said reference signal received by said reference signal receiving means.

9. An apparatus according to claim 6, further comprising:
another communicating means for communicating with another control apparatus;
memory means for holding said time information on said video signal reproducing apparatus which was obtained by making the communication by said communicating means; and
reference signal receiving means for receiving a reference signal which is shared by said video signal reproducing apparatus,
and wherein when said time information on said video signal reproducing apparatus is requested from said another control apparatus through said another communicating means, said control means directly responds to said another control apparatus on the basis of said time information held in said memory means without allowing said communicating means to communicate with said video signal reproducing apparatus.

10. An apparatus according to claim 9, wherein
a current state on said video signal reproducing apparatus which was obtained by making the communication by said communicating means is further held in said memory means, and
when said time information on said video signal reproducing apparatus is requested from said another control apparatus through said another communicating means, said control means directly responds to said another control apparatus on the basis of said current state and said time information held in said memory means without allowing said communicating means to communicate with said video signal reproducing apparatus.

11. A control method of controlling a reproduction of a video signal by a video signal reproducing apparatus on the basis of time information, comprising:
a communicating step of communicating with said video signal reproducing apparatus which reproduces and outputs the video signal on the basis of said time information corresponding to an edition unit of said video signal; and
a control step of controlling said video signal reproducing apparatus so as to reproduce said video signal on the basis of said time information on said video signal reproducing apparatus which was obtained in said communicating step,
wherein in the control step, said time information on said video signal reproducing apparatus is obtained at a period longer than said edition unit.

12. A method according to claim 11, wherein
in said communicating step, a current state of said video signal reproducing apparatus is obtained by communicating with said video signal reproducing apparatus, and
in said control step, said period for obtaining said time information from said video signal reproducing apparatus is set in accordance with said obtained current state.

13. A method according to claim 11, further comprising a reference signal receiving step of receiving a reference signal which is shared by said video signal reproducing apparatus,
and wherein in said control step, said time information on said video signal reproducing apparatus is presumed on said edition unit basis
by using said time information on said video signal reproducing apparatus obtained by said communicating step and said reference signal received by said reference signal receiving step.

14. A method according to claim 11, further comprising:
another communicating step of communicating with another control apparatus; and
a storing step of storing said time information on said video signal reproducing apparatus which was obtained by making the communication by said communicating step into a memory,
and wherein in said control step,
when said time information on said video signal reproducing apparatus is requested from said another control apparatus through said another communicating step, a response is directly made to said another control apparatus on the basis of said time information stored in said memory without allowing said communicating step to communicate with said video signal reproducing apparatus.

15. A method according to claim 14, wherein
in said storing step, a current state on said video signal reproducing apparatus which was obtained by making the communication by said communicating step is further stored, and
in said control step, when said time information on said video signal reproducing apparatus is requested from said another control apparatus through said another communicating step, a response is directly made to said another control apparatus on the basis of said current state and said time information stored in said memory without allowing said communicating step to communicate with said video signal reproducing apparatus.

16. A recording medium on which a control method of controlling a reproduction of a video signal by a video signal reproducing apparatus on the basis of time information has been recorded, wherein said control method comprises:
a communicating step of communicating with said video signal reproducing apparatus which reproduces and outputs said video signal on the basis of said time information corresponding to an edition unit of said video signal; and
a control step of controlling said video signal reproducing apparatus so as to reproduce said video signal on the basis of said time information on said video signal reproducing apparatus which was obtained in said communicating step,
wherein in the control step, said time information on said video signal reproducing apparatus is obtained at a period longer than said edition unit.

17. A medium according to claim 16, wherein
in said communicating step, a current state of said video signal reproducing apparatus is obtained by communicating with said video signal reproducing apparatus, and
in said control step, said period for obtaining said time information from said video signal reproducing apparatus is set in accordance with said obtained current state.

18. A medium according to claim 16, wherein
said control method further comprises a reference signal receiving step of receiving a reference signal which is shared by said video signal reproducing apparatus, and
in said control step, said time information on said video signal reproducing apparatus is presumed on said edition unit basis
by using said time information on said video signal reproducing apparatus obtained by said communicating step and said reference signal received by said reference signal receiving step.

19. A medium according to claim 16, wherein said control method further comprises:
another communicating step of communicating with another control apparatus; and
a storing step of storing said time information on said video signal reproducing apparatus which was obtained by making the communication by said communicating step into a memory, and
in said control step,
when said time information on said video signal reproducing apparatus is requested from said another control apparatus through said another communicating step, a response is directly made to said another control apparatus on the basis of said time information stored in said memory without allowing said communicating step to communicate with said video signal reproducing apparatus.

20. A medium according to claim 19, wherein
in said storing step, a current state on said video signal reproducing apparatus which was obtained by making the communication by said communicating step is further stored, and
in said control step, when said time information on said video signal reproducing apparatus is requested from said another control apparatus through said another communicating step, a response is directly made to said another control apparatus on the basis of said current state and said time information stored in said memory without allowing said communicating step to communicate with said video signal reproducing apparatus.
